(19) United States
(12) Patent Application Publication
(10) Pub. No.: US 2004/0257295 A1
(43) Pub. Date: Dec. 23, 2004

(54) External antenna

(75) Inventor: Nobuyuki Tada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/816,191

(22) Filed: Apr. 2, 2004

(30) Foreign Application Priority Data
Apr. 2, 2003 (JP) 2003-099621

(51) Int. Cl. H01Q 21/00

(52) U.S. Cl. 343/867; 343/742; 343/702

(57) ABSTRACT

Cartridge memory 2 is diagonally placed so that two sides 23a and 23b of a loop antenna 23 of the cartridge memory 2 are in adjacent to two neighboring surfaces 11a and 11b of cartridge case 11. An external antenna 4 has two tip portions 41 and 42 in adjacent to these two surfaces 11a and 11b. Such an external antenna can enhance communication with a cartridge memory diagonally placed within a magnetic tape cartridge.

### BACKGROUND ARTS

1. Field of the Invention

The present invention relates to an external antenna which transmits to and receives from data a non-contact integrated circuit (hereinafter sometimes referred to as “non-contact IC”) placed within a case. This application is based on Japanese Patent Application No. 2003-099621 filed on Apr. 2, 2003, and the content of which is incorporated by reference.

2. Description of the Prior Arts

In recent years, various products to which a non-contact IC (integrated circuit) is applied have been put into a market. As an example, a magnetic tape cartridge having a cartridge memory with a non-contact IC built therein can be mentioned. Information within the cartridge memory provided within the magnetic tape cartridge is used in various external apparatuses such as a tape drive and a robot hand within a library and, thus, techniques which make it possible to be accessed with the tape cartridge memory in a multi-direction have hitherto been developed.

As such techniques, a technique has been known in which a rectangular cartridge memory wherein a loop-shaped antenna (hereinafter referred to as “loop antenna”) is formed on the outer circumference is slanted 45° relative to the bottom surface or where two sides of the loop antenna approach two sides of the cartridge case by slanting the loop antenna 45° relative to the bottom surface (for example, see Japanese Patent Laid-Open No. 2002-140879, and Japanese Patent Laid-Open No. 11-339436). In such a technique, the data is exchanged by coming a loop shaped external antenna provided on a flat portion of an external device close to either of the two sides of the tape cartridge.

However, in the prior art techniques, since only one side of the loop antenna in the external antenna is contributed to transmission/receiving with the loop antenna formed on the cartridge memory, it has been difficult to make communication quality good. Specifically, as shown in FIG. 7, at a portion near one side 61 of a substantially rectangular loop antenna 6, which is an-external antenna, a magnetic field becomes parallel to a cartridge memory CM, which is diagonally placed, making it difficult to obtain binding of the magnetic field, as a result, communication cannot be performed. On the other hand, at a portion opposite one side 62 (Range A in the figure), the magnetic field becomes perpendicular to the cartridge memory CM, binding of the magnetic field required for communication can be obtained, and thus, only the side 62 is contributed to transmission/receive to the cartridge memory CM in conventional. For this reason, when such a plane type loop antenna 6, which is the external antenna, is used, the position of transmission/receiving with the cartridge memory CM is restricted, and there is also the problem that the efficiency is reduced by half. Particularly, when being communicated with a magnetic tape cartridge memory in the state where a magnetic tape cartridge is accommodated within a housing case, since a distance between the external antenna and the cartridge memory becomes large, the communication quality thereof has been desired to be enhanced.

An object of the present invention is to provide an external antenna which can enhance communication with a cartridge memory diagonally placed within a magnetic tape cartridge.

### SUMMARY OF THE INVENTION

According to the present invention, there is provided an external antenna which performs transmission/receiving with a non-contact type memory diagonally placed within a case in such a manner that a loop antenna of the non-contact type memory is in adjacent to neighboring two surfaces of the case, the external antenna comprising a loop antenna having a route in adjacent to said two surfaces.

The term “non-contact type memory” used herein comprises a loop antenna formed around an outer circumference and IC tip (integrated circuit), and makes a communication in a non-contact manner to an external antenna or through an electric wave or electromagnetic induction.

According to the present invention, when being communicated with a non-contact type memory diagonally placed within the case, first the external antenna approaches two surfaces in adjacent to the loop antenna of the non-contact type memory. If the external antenna approaches these two surfaces, a portion in adjacent to these two surfaces amongst the external antenna becomes in adjacent to two portions (two sides in the case of a rectangular loop antenna) in adjacent to these side amongst the loop antenna within the case, whereby communication is made between the loop antenna within the case at two portions and the external antenna. This can enhance communication quality.

In the present invention, the antenna in adjacent to these two surfaces is a part of substantially L-shaped loop antenna.

According to this configuration, only when a conventionally used loop antenna is bent into an L-shape, an antenna in adjacent to these two surfaces can be formed. Consequently, a power required for transmitting data to the external antenna or receiving data from the external antenna can be reduced to a level not higher than the conventional electric power. Also, in this case, a transmission/receiving range (distance) can be widened.

Furthermore, according to the present invention, when three portions of the loop antenna of the non-contact type memory are provided so as to be in adjacent to three surfaces of the case, one portion of the L-shaped loop antenna is in a substantially straight shape to be in adjacent to these three surfaces.

According to this configuration, when being communicated with a non-contact type memory diagonally placed within the case, first the L-shaped external antenna approaches so as to cover the corner portion. When the external antenna approaches the case as described above, two sides positioned at the tips of the L-shape and one side, which is substantially straight line are in adjacent to three portions of the loop antenna in the case. Consequently, since the communication between the non-contact type memory and the external antenna are performed at three portions, the communication quality is much more enhanced.

Also, the present invention is characterized in a communication method of an external antenna with a non-contact type memory diagonally placed within a case. Specifically, the present invention relates to a communication process for communicating an external antenna with a non-contact type memory diagonally placed within a case in such a manner that a loop antenna is in adjacent to neighboring two surfaces of the case, wherein data communication is performed by pacing the external antenna so that the two portions of the antenna are in adjacent to these two surfaces at the time of communication.

### BRIEF DESCRIPTION OF THE DRAWINGS

FIG. 1 is a perspective view showing an external antenna according to the first embodiment of the present invention.

FIG. 2A is a cross-sectional view showing a relation between an external antenna and a cartridge memory, and FIG. 2B is a top view showing a relation between an external antenna and a cartridge memory.

FIG. 3 is a cross-sectional view showing a state of communication between the external antenna and the cartridge memory.

FIG. 4 is a perspective view showing an external antenna according to the second embodiment of the present invention.

FIG. 5 is a perspective view showing an external antenna according to another embodiment of the present invention.

FIG. 6 is a perspective view showing an external antenna according to still another embodiment of the present invention.

FIG. 7 is a cross-sectional view showing a relation between the conventional external antenna and a cartridge memory.

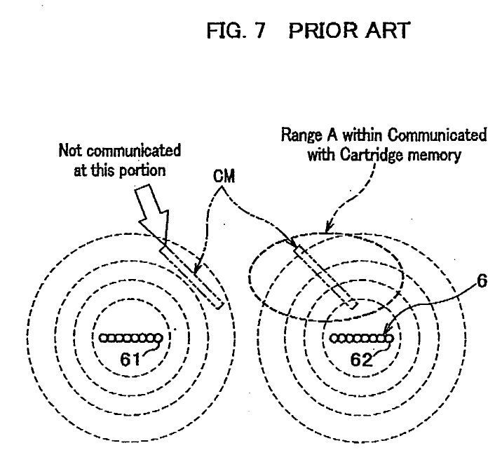

### DESCRIPTION OF THE PREFERRED EMBODIMENTS

### First Embodiment

First embodiment of the present invention will be described by referring to the drawings.

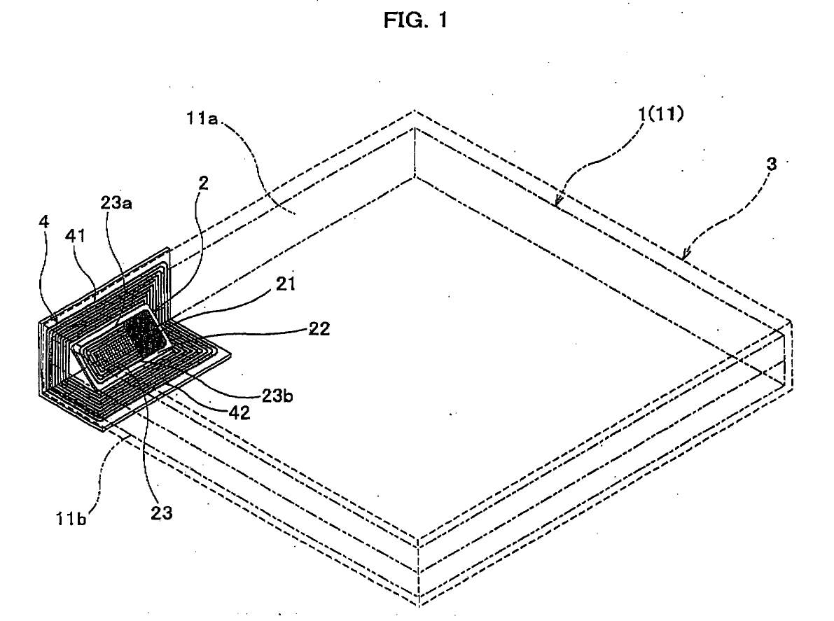

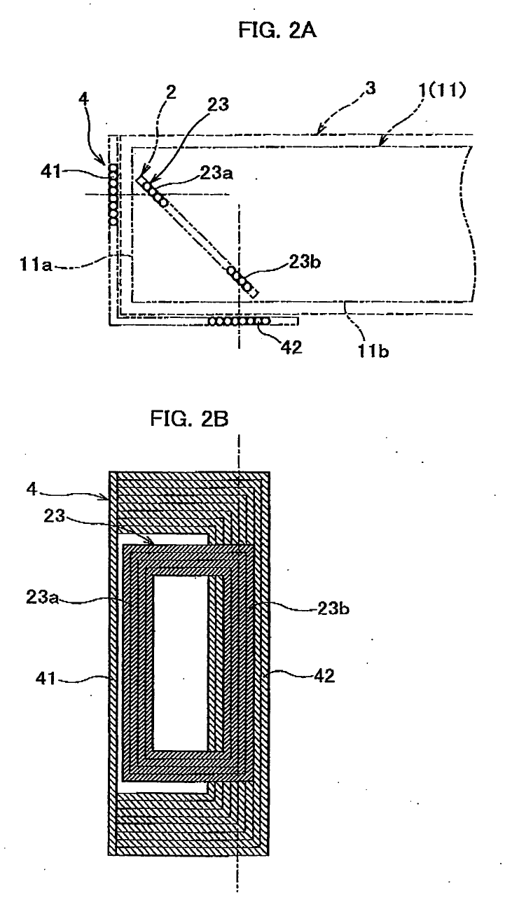

FIG. 1 is a perspective view showing an external antenna according to the first embodiment of the present invention, FIG. 2A is a cross-sectional view showing a relation between an external antenna and a cartridge memory, and FIG. 2B is a top view showing a relation between an external antenna and a cartridge memory.

As shown in FIG. 1, a magnetic tape cartridge 1 is composed of a vertically divided cartridge case 11 having a magnetic tape (not shown) for recording data, a cartridge memory (non-contact type memory) 2 and the like accommodated therein. The magnetic tape cartridge 1 is stored in a housing case 3 made of a plastic or such at the product state at the time of shipment. In the product state, in order to manage the magnetic tape cartridge 1, data communication (transmission/receiving) is made between the cartridge memory 2 within the magnetic tape cartridge 1 and an external antenna 4.

The cartridge memory 2 is an electric part, whole of which is a substantially rectangular, thin piece state. The cartridge memory 2 is composed of a main body comprising an IC tip (integrated circuit) (not shown) sealed in a glove top 32, which is sealing agent made of a resin, the IC tip being wired to a loop antenna 23 printed on a substrate 22. The loop antenna 23 has a substantially rectangular shape by winding a lead line around outer circumference of the cartridge memory 2 on several times. The cartridge memory 2 is diagonally placed at approximately 45° relative to a bottom 11b so that long side portions 23a and 23b, which are opposite two sides amongst sides making up the rectangular shape are in adjacent to a side surface 11a and bottom surface 11b, which are two neighboring surfaces of the cartridge case 11.

The external antenna 4 is formed by bending a conductive antenna etched on a flexible substrate in a loop state into a substantially L-shape. By the formation of the external antenna 4 as described above, when the external antenna 4 approaches the magnetic tape cartridge 1, two sides 41, and 42 positioned at the tips of the L-shape (hereinafter simply referred to as “tip portions 41 and 42”) are in adjacent to the side surface 11a and the bottom surface 11b. Specifically, the external antenna 4 is composed of a loop antenna having the tip portions 41 and 42, which are routes in adjacent to these two surfaces 11a and 11b. Furthermore, when the external antenna is placed at a prescribed position in order to be communicated with the cartridge memory, these tip portions 41 and 42 are formed so as to be substantially parallel to these long side portions 23a and 23b.

As shown in FIG. 2A and FIG. 2B, the external antenna 4 is formed so that the centers of the tip portions 41 and 42 in the width direction are accorded with the centers of the long side portions 23a and 23b in the width direction, respectively. Furthermore, the tip portions 41 and 42 are formed to each has a width larger than that of long side portions 23a and 23b. By forming the tip portions 41 and 42 as just mentioned, the lines of magnetic force generated around the tip portions 41 and 42 surround the long side portions 23a and 23b. Specifically, the lines of magnetic force generated by the external antenna 4 enter into the loop antenna 23 of the cartridge memory in a larger amount. It is noted that for the convenience of the explanation, FIG. 2 omits the glove top 21 of the cartridge memory and the like in FIG. 1, and only shows the loop antenna 23 and the external antenna 4.

A communication method between the external antenna 4 according to the present invention with the cartridge memory 2 will be described.

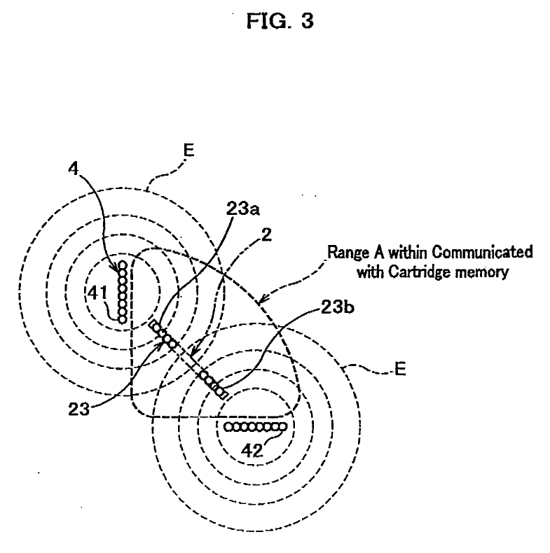

As shown in FIG. 1, first the external antenna 4 approaches two sides 11a and 11b of the magnetic tape cartridge 1. When the external antenna 4 approaches the housing case 3 having the magnetic tape cartridge 1 accommodated therein, the tip portions 41 and 42 amongst the external antenna 4 approach the long side portions 23a and 23b of the cartridge memory 2. As shown in FIG. 3, when a signal is running through the external antenna 4 to generate a magnetic field E, communication between these tip portions 41 and 42 and the loop antenna 23 comprising two sides 23a and 23b of the cartridge memory 2 is performed. In this case, the range A which can be communicated (transmitting/receiving) between the cartridge memory 2 diagonally placed and the external antenna 4 extends from a portion near the tip portion 41 to a portion near the tip portion 42.

As described above, the following advantages can be obtained in the first embodiment:

Since the long side portions 23a and 23b of the cartridge memory are in adjacent to the tip portions 41 and 42 of the external antenna, an amount of the line of magnetic field is increased in comparison with the conventional case, a quality of communication with the cartridge memory 2 diagonally placed can be enhanced. Furthermore, since the communication quality can be enhanced as described above, even in the case where a communication distance between the cartridge memory 2 and the external antenna 4 is increased by accommodating the magnetic tape cartridge 1 within the housing case 3, the management of the magnetic tape cartridge 1 can be carried out in a good manner by effectively utilizing information within the cartridge memory 2.

Since the external antenna 4 can be formed only by bending a loop antenna, a conventionally used plane type loop antenna can be used as it is. Consequently, a power required for transmitting data from the external antenna can be reduced to a level not higher than the conventional electric power. Also, in this case, a transmission/receiving range (distance) can be widened.

### Second Embodiment

Second embodiment of the present invention will be described by referring to the drawings. Since this is an embodiment in which part of the external antenna 4 according to the first embodiment is altered, the constitution elements similar to those of the first embodiment are assigned to the same symbols and the same numbers, and the detailed description thereof will be omitted.

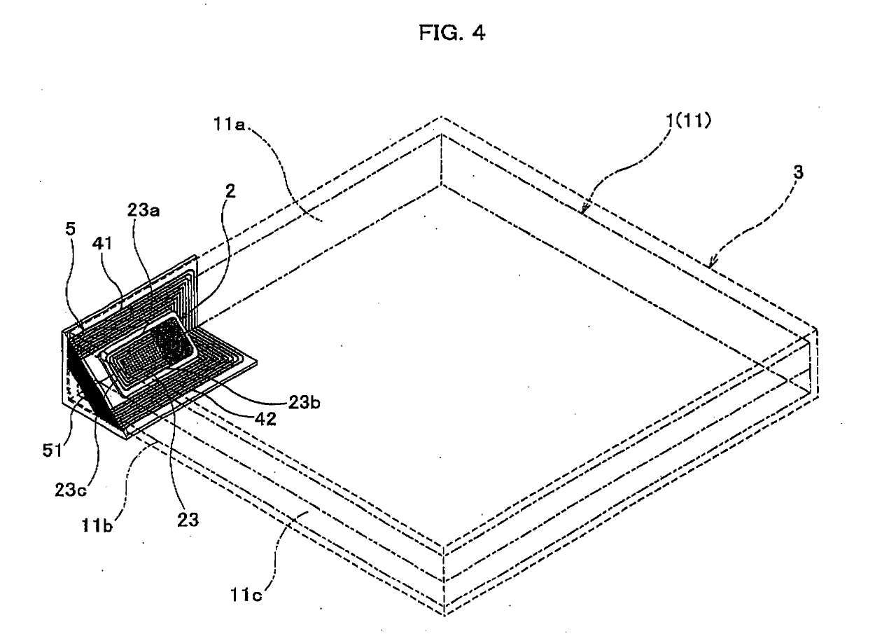

As shown in FIG. 4, in an external antenna 5, one of the external antenna 4 according to the first invention having been bent into a substantially L-shape is formed into a substantially straight line as a liner portion 51. The liner portion 51 is formed so as to be substantially parallel to a short side portion 23c of the loop antenna 23 formed on the cartridge memory 3 diagonally placed within the cartridge case 11.

The cartridge memory 2 is placed in a corner of the cartridge case 11 in such a manner that three sides, i.e., the long side portions 23a and 23b, and the short side portion 23c are in adjacent to three sides of the cartridge case 2, i.e., the side surface 11a and the bottom surface 11b, and a side surface 11c perpendicular thereto. The linear portion 51 of the external antenna 5 is formed so that when the external antenna 5 is in adjacent to three surfaces 11a to 11c of the cartridge case 11, the center of the linear portion 51 in the width direction is accorded with the center of the short side portion 23c in the thickness direction, and the width of the linear portion 51 formed is larger than the thickness of the short side portion 23c. By forming the linear portion 51 as described above, the line of magnetic force generated around the linear portion 51 surrounds short side portion 23c, increasing the magnetic line entering in the loop antenna 23.

A communication method between the external antenna 5 according to this embodiment with the cartridge memory 2 will be described.

As shown in FIG. 4, first the external antenna 5 approaches three surfaces 11a to 11c of the magnetic tape cartridge 1. When the external antenna 5 approaches the housing case 3 having the magnetic tape cartridge 1 accommodated therein, the tip portions 41 and 42, and the linear portion 51 amongst the external antenna 5 approach the long side portions 23a and 23b and the short side portion 23c of the cartridge memory 2. When a signal is running through the external antenna 5 to generate a magnetic field, communication between these tip portions 41 and 42 as well as the linear portion 51 and the loop antenna 23 comprising three sides 23c to 23c of the cartridge memory 2 is performed.

As described above, the following advantages can be obtained in the second embodiment:

Since three sides 23a to 23c are in adjacent to the tip portions 41 and 42 and the linear portion 51 of the external antenna, the line of the magnetic field passing within the loop antenna 23 is increased in comparison with the conventional case, much more enhancing the communication quality.

While the embodiments of the present invention have been described, but it should be noted the present invention should not be restricted thereto, and various modification can be made.

(i) While the external antenna 4 is formed by bending a conductive antenna etched on a flexible substrate in a loop state, the present invention is not restricted thereto. For example, the conductive line is once formed into a loop in a plane state, which is then bent, to form the external antenna 4. The external antenna 5 in the second embodiment is also freely produced. For example, it may be produced by winding a conductive line around a pattern having a shape of the external antenna 5.

(ii) In these embodiments, the external antennas 4 and 5 are formed by deforming one loop antenna, but the present invention is not restricted thereto. For example, loop antennas having shapes of the first and second embodiment may be formed by binding a plurality of plane type antennas. Alternatively, a plurality of plane type loop antennas may be provided on a plurality of plane portions perpendicular to each other to approach each surface of the cartridge case 11.

(iii) In these embodiments, the external antennas 4 and 5 are used in an apparatus for managing the magnetic tape cartridge 1 accommodated within the housing case 3, but the present invention is not restricted thereto For example, these external antennas 4 and 5 may be used in various external apparatuses such as a tape drive and a robot hand within a library.

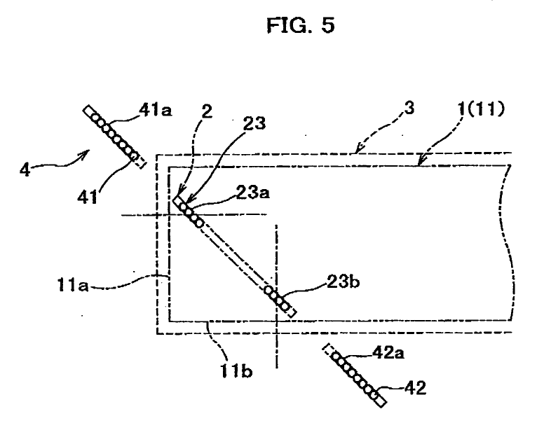

(iv) In the embodiment, the surfaces of the tip portions 41 and 42 (surfaces formed by the conductive coil) are formed so as to be parallel to the two surfaces 11a and 11b, but the present invention is not restricted thereto. For example, as shown in FIG. 5, surfaces 41a and 42a of the tip portions 41 and 42 may be arranged to be parallel to the cartridge memory within the cartridge case 11.

(v) In the embodiment, the external antenna 4 is a rectangular loop antenna, but the present invention is not restricted thereto. For example, by bending a circular loop antenna into a substantially L-shape, a portion contributing to transmitting and receiving with the cartridge memory 2 is formed into a semi-circular shape.

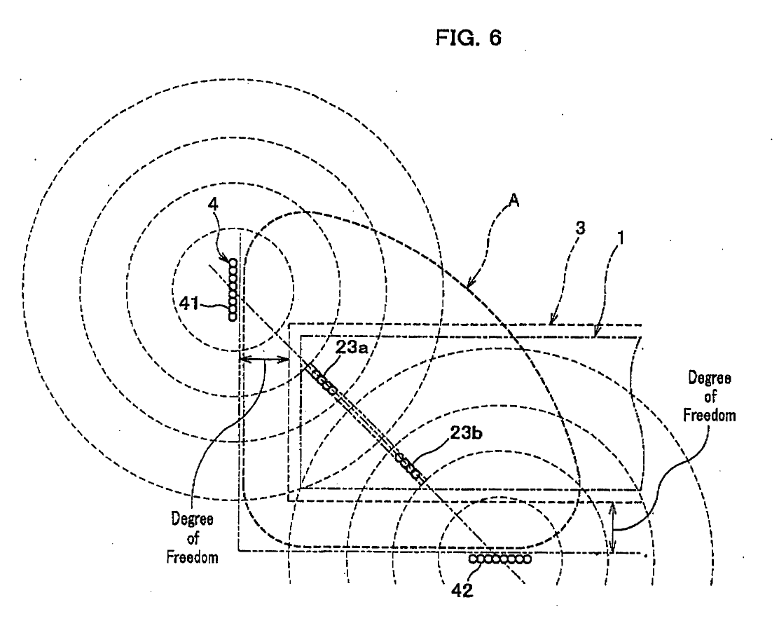

(vi) The size of the external antenna can be freely set. For example, as shown in FIG. 6, the external antenna 4 is largely formed so that the tip portions 41 and 42 are far from each other, making it possible to enhance the range A which can be communicated, and increasing a degree of freedom in the positional relationship between the external antenna 4 and the cartridge memory 3. Although not shown in figure, for example, longer lengths of the tip portions 41 and 42 (the lengths in the direction perpendicular to the paper) can enhance the range A which can be communicated in the lengthwise direction of the tip portions 41 and 42.

What is claimed is:

1. An external antenna which performs transmission/receiving with a non-contact type memory diagonally placed within a case in such a manner that a loop antenna of the non-contact type memory is in adjacent to neighboring two surfaces of the case, the external antenna comprising a loop antenna having a route in adjacent to said two surfaces.

2. The external antenna according to claim 1, wherein said external antenna possesses tips portion in adjacent to neighboring two surfaces of the case.

3. The external antenna according to claim 1, wherein the antenna in adjacent to said two surfaces is a part of substantially L-shaped loop antenna.

4. The external antenna according to claim 1, wherein three portions of the loop antenna of the non-contact type memory are provided so as to be in adjacent to three surfaces of the case, and one portion of the L-shaped loop antenna is in a substantially straight shape to be in adjacent to these three surface

5. The external antenna according to claim 3, wherein said route comprises tips of the L-shape.

6. The external antenna according to claim 3, which is produced by deforming one loop antenna into an L-shape.

7. The external antenna according to claim 1, which is largely formed so that the tip portions of said external antenna are far from each other.

8. A communication process for communicating an external antenna with a non-contact type memory diagonally placed within a case in such a manner that a loop antenna is in adjacent to neighboring two surfaces of the case, wherein data communication is performed by placing the external antenna so that the two portions of the antenna are in adjacent to these two surfaces at the time of communication.
